(19) United States
(12) Patent Application Publication
(10) Pub. No.: US 2025/0360713 A1
(43) Pub. Date: Nov. 27, 2025

(54) Printing Device and Method for Maintaining a Printing Device

(71) Applicant: CANON KABUSHIKI KAISHA, Tokyo (JP)

(72) Inventors: Laurentius P.E.G. KUIJPERS, Someren (NL); Age BAKKER, Broekhuizenvorst (NL); Richard VAN ENCKEVORT, Velden (NL); Yagiz ALTUNAY, Eindhoven (NL); Tobias R. BREINTNER, Lengdorf (DE); Walter BRENNER, Oberding (DE); Kai-Yannic SCHÖNEWOLF, Feldkirchen (DE); Franz J. BITZER, Hohenlinden (DE); Lucian PETRUT, Poing (DE)

(21) Appl. No.: 19/214,676

(22) Filed: May 21, 2025

(30) Foreign Application Priority Data
May 27, 2024 (EP) 24178245.7
Oct. 23, 2024 (EP) 24208452.3

(51) Int. Cl. B41J 2/165; B41J 2/17

(52) U.S. Cl. CPC B41J 2/16508; B41J 2/1742; B41P 2235/20

(57) ABSTRACT

A printing device includes a print unit configured to, in a printing operation, apply a predetermined pattern of fluid onto a recording medium, the print unit including a plurality of nozzles. The printing device includes a purge tray, the purge tray being configured to, in a purging operation, collect fluid purged from the print unit, and a recording medium transport unit configured to transport the recording medium in a transport direction. The print unit has a length extending in a printing range direction, the printing range direction being perpendicular to the transport direction. The purge tray has a length extending in the printing range direction, the length of the purge tray being smaller than the length of the print unit. The purge tray is configured to, in the purging operation, move underneath the print unit in the printing range direction.

### CROSS-REFERENCE TO RELATED APPLICATIONS

This application claims priority to European Patent Application No. 24178245.7 filed on May 27, 2024 and European Patent Application No. 24208452.3 filed on Oct. 23, 2024, all of which are incorporated by reference herein in their entirety.

### FIELD OF THE DISCLOSURE

The disclosure relates to a printing device. The disclosure further relates to a method for maintaining a printing device.

### DESCRIPTION OF THE RELATED ART

Inkjet printers are known in the art. In an inkjet printer, an image is formed by ejecting small droplets of ink and applying these droplets in a predetermined pattern to form an image onto a recording medium. The small droplets of ink are generally ejected through nozzles of an inkjet print head. Nozzles are tiny apertures in the print head. Nozzles are vulnerable for drying out or being contaminated. In such case, the nozzle may not be able to eject droplets of ink in the desired way or may not be able to eject droplets at all. To solve and/or prevent malfunctioning of nozzles, maintenance may be done. Known types of maintenance actions may include purging. Purging is often done in combination with wiping.

When purging nozzles, it is preferable to collect the purged fluids, as these may otherwise pollute the print system. It is known to collect the purged fluids in a purge tray, which may be positioned under the print unit when purging. Generally, the purge tray has an opening that has at least the same dimensions as the nozzle area(s) of the print unit from which the droplets are collected. Hence, purge trays are relatively big. When the purge trays are not needed for collecting purged fluid, for example when the printer is printing, the purge trays need to be stored. In case the purge tray is relatively big, storing the purge tray may require relatively large space. This is unwanted, as space within printing systems is scarce.

### SUMMARY OF THE DISCLOSURE

The disclosure is directed to an inkjet printer including a purge tray that requires less space. The disclosure is further directed to provide a method for maintaining a printer using a purge tray that requires less space.

The disclosure is directed to a printing device, the printing device including at least one print unit configured to, in a printing operation, apply a predetermined pattern of fluid onto a recording medium, the print unit including a plurality of nozzles; a purge tray, the purge tray being configured to, in purging operation, collect fluid purged from the at least one print units; a recording medium transport unit configured to transport the recording medium in a transport direction; wherein the at least one print unit has a length extending in a printing range direction, the printing range direction being essentially perpendicular to the transport direction, wherein the purge tray has a length extending in the printing range direction, the length of the purge tray being smaller than the length of the at least one print unit, and wherein the purge tray is configured to, in the purging operation, move underneath the at least one print unit in the printing range direction.

A printing apparatus may also be referred to as printer, printer device or printing device.

The printing device includes at least one print unit, the print unit being configured to, in printing operation, apply a predetermined pattern of fluid onto the recording medium. The print unit may be a single ink applicator or an assembly of ink applicators. An example of a single ink applicator is a single print head. An example of an assembly of ink applicators is a print bar including a number of ink jet print heads. Inkjet print heads typically include a plurality of nozzles. Fluids, such as ink, primer or overcoat may be expelled in response to a stimulus provided to the ink in proximity of the nozzle. The stimulus may be for example applying an amount of heat to locally heat the ink (bubble jet) or applying a pressure using e.g. a piezoelectric element to ink in proximity of the nozzle (piezo inkjet). The plurality of nozzles of the print head may be provided in a nozzle surface. In a printing operation, droplets of ink may be expelled from the print head via the plurality of nozzles. If the print unit is not in printing operation, no ink may be expelled from the print head via the plurality of nozzles. In case no ink is expelled via the plurality of nozzles, some of the fluid in the print unit may evaporate, which may result in a change in viscosity of the liquid within the print unit, or may even result in the formation of solid precipitation, such as precipitation formed by solid components of the fluids (e.g. resins and/or pigments).

The printing device further includes a purge tray, the purge tray being configured to, in a purging operation, collect fluid purged from the at least one print units. To regenerate nozzles, when precipitation has formed, or ink viscosity has risen, and/or to prevent precipitation to form in the nozzles, the nozzles may be purged. When purging, ink may be expelled through the nozzles. This may be done by applying jetting pulses, or the fluid may be pushed out of the nozzles in another way. The purge tray is configured to, in the purging operation, collect fluid purged from the at least one print units. The purge tray may have an opening for receiving the purged fluid from the nozzles. The purge tray may further have a bottom wall and one or more side walls. Alternatively, the purge tray may have a single wall, for example a wall having a rounded shape, for example a semi-spherical wall or a semi-ovoid wall. The one or more walls may together form a container for containing the purged fluid. Optionally, the purge tray may include a drain for removing the purged fluid from the purge tray. Optionally, or alternatively, the purge tray may be taken out by an operator to remove purged fluid, or the printer may be provided with a mechanism for pouring the purged liquid out of the purge tray.

The printing device includes a recording medium transport unit for transporting the recording medium in a transport direction. The recording medium may be any suitable type of media, including media in the form of a sheet or a web. The recording medium transport unit may include a belt and/or one or more rollers for transporting the recording medium in the transport direction.

The printing device may further be provided with a recording medium input module for inputting the recording medium into the printer. Optionally, the printing device may further be provided with a recording medium output module for outputting the recording medium from the printer.

In the printing device according to the present disclosure, the at least one print unit has a length extending in a printing range direction, the printing range direction being perpendicular to the transport direction. Further, in the printing device according to the present disclosure, the purge tray has a length extending in the printing range direction, the length of the purge tray being smaller than the length of the at least one print unit. Hence, the length of the purge tray in the printing range direction, which is perpendicular to the transport direction, is smaller than the length of the print unit.

In the printing device according to the present disclosure, the purge tray is configured to, in the purging operation, move underneath the at least one print unit in the printing range direction. Because in the printing range direction, the length of the purge tray is smaller than the length of the print unit, the purge tray may need to move from one side of the print unit to the other side of the print unit in the printing range direction. Because the length of the purge tray is smaller than the length of the print unit, the purge tray is relatively small, at least in the printing range direction and hence, limited space is needed within the printing system to store the purge tray when the print unit is not purging.

Further, the same type of purge tray can be used in printers having different dimensions, as the length of the purge tray is smaller than the length of the print unit.

The position and the movement of the purge tray may be controlled using suitable control means and suitable moving means. The control means may include for example motion control software. For example, the position of the purge tray may be derived from its speed and starting position. By deriving the position of the purge tray, the timing of purging may be determined and the print unit may be controlled such that the timing of the purging of the (groups) of nozzle(s) is synchronized with the movement of the purge tray.

In an embodiment, the printing device further includes a wiping unit, the wiping unit being configured to, in a wiping operation, move underneath the at least one print unit in the printing range direction.

Unwanted substances, including fluids and/or solid deposits may be present on the nozzle surface. The wiping unit may be configured to, in a wiping operation, contact a surface of the print unit. The surface may preferably be the nozzle surface. By contacting a surface of the print unit, while moving underneath the print unit, the wiping unit may remove liquids or solids materials from the surface of the print unit, thereby cleaning the surface of the print unit. Examples of wiper units are wiper blades and tissue wipers.

In a further embodiment, the wiping unit is a tissue wiper. A tissue wiper may include a tissue. The tissue may be made of any suitable material, including woven materials and non-woven materials. Optionally, the tissue wiper may include means for moving the tissue. The tissue may be moved within the tissue wiper and/or relative to the surface of the at least one print unit, for example using one or more rollers. The tissue wiper may include a web supply unit, such as a web supply roller and a web take up unit, such as a web take up roller. The web supply roller may be provided with an amount of clean tissue; the web take up unit may be configured to take up used tissue. The tissue wiper may optionally include a liquid supply for wetting the tissue. Optionally, the tissue wiper may include a casing.

In an embodiment, the wiper unit is configured to, in a wiping operation, move in the printing range direction. Preferably, the wiper unit may follow the purge tray. Preferably, the distance between the purge tray and the wiper unit is essentially constant in the wiping operation. Preferably, the distance between the purge tray and the wiper unit is relatively small. For example, the distance between the purge tray and the wiper unit may be in the range of from 0 mm to 100 mm, such as from 5 mm to 30 mm.

In this way, it may be prevented that material, such as ink or contamination pollutes the printing device.

In an embodiment, the printing device further includes a cleaning tray, the cleaning tray being configured to support the purge tray. In case the printing device includes one or more wiping units, the cleaning tray may support the one or more wiping units.

The cleaning tray may be moveable with respect to the at least one print unit. The cleaning tray may be moveable with respect to the at least one print unit in the printing range direction.

The clean tray may be driven using suitable driving means. The driving means may include for example a motor and optionally a gearbox. The clean tray may be provided with wheels or gearwheels. The wheels or gear wheels may be moveable along a guide rail or rack.

The purge tray may be moveable with respect to the cleaning tray. The purge tray may be moved using suitable driving means. The driving means may include for example a motor and optionally a gearbox. The clean tray may be provided with wheels or gearwheels. The wheels or gear wheels may be moveable along a guide rail or rack.

The wiping unit may be moveable with respect to the cleaning tray. Alternatively, the wiping unit may be stationary with respect to the cleaning tray.

In an embodiment, one of the side walls of the purge tray is configured to touch the wiping unit. In this way, the at least one print unit may be wiped shortly after purging. Further, the purge tray and the wiping unit are in close proximity of one another, which limits the amount of space needed.

In an embodiment, in a printing operation, the purge tray and the wiping unit are positioned in a home position, wherein in the home position, one of the purge tray or the wiping unit is placed above the other one of the purge tray or the wiping unit.

In purging operation, the purge tray may be moving underneath the at least one print unit in the printing range direction.

In case the purge tray is not in purging operation, for example when the at least one print unit is in a printing operation, and/or when the at least one print unit is capped, the purge tray may be in the home position. The home position of the purge tray may be a position in the printing device more remote from the at least one print unit, as compared to the position of the purge tray in the purging operation. The home position may preferably not be in a path of paper transport. For example, the home position may be adjacent to the path of paper transport.

In printing operation, the wiping unit may also be in the home position. When going from a position underneath the at least one print unit to the home position, the wiping unit and the purge tray may slide together. In the home position, at least part of the wiping unit may be contained in the capping tray.

In an embodiment, the purge tray has a length in a first direction, the first direction being essentially parallel to the transport direction, the at least one print unit having a length in the first direction, wherein the length of the purge tray in the first direction is at least twice the length of the print unit in the first direction.

Typically, a printing device includes more than one print unit, for example at least four print units. In case the length of the purge unit in the first direction is at least twice the length of the print unit in the first direction, the purge tray can collect purged fluid from at least two print units. Preferably, the length of the purge tray in the first direction is at least the sum of the length of all print units in the first direction plus the sum of the space in between the print units, in the first direction. In this case, the length of the purge tray is sufficient to collect purged fluid from all print units within the printing device.

The length of the print unit in the first direction may be in the range of from 20 mm to 150 mm, such as from 30 mm to 100 mm. The length of the purge tray in the first direction may be in the range of from 50 mm to 50000 mm, such as from 300 mm to 2000 mm.

In a further embodiment, the printing device includes at least two wiping units.

It is preferred that a single wiping unit is not used for print units configured to eject different types of fluid. This prevents unwanted mixing of fluids on the surface of the print unit. Preferably, one wiping unit is provided per print unit in the printing system.

In an aspect of the disclosure, a method for maintaining a printing device according to the present disclosure is provided, the method includes the steps of: Moving the purge tray underneath the at least one print unit in the printing range direction; Purging at least part of the nozzles that are positioned above the purge tray, while not purging the nozzles that are not positioned above one of the purge tray or the wiping unit.

By maintaining a printing device, the printing device may be kept in good condition and/or its condition may be restored when the condition of the printing device was insufficient. Maintaining a printing device may be done by purging at least part of the nozzles. Optionally, maintaining the printing device may include additional actions.

The printing device further includes a purge tray, the purge tray configured to, in a purging operation, collect fluid purged from the at least one print units. To regenerate nozzles, when precipitation has formed, or ink viscosity has risen, and/or to prevent precipitation to form in the nozzles, the nozzles may be purged. When purging, ink may be expelled through the nozzles. This may be done by applying jetting pulses, or the fluid may be pushed out the nozzles in another way. The purge tray is configured to, in a purging operation, collect fluid purged from the at least one print unit. The purge tray may have an opening for receiving the purged fluid from the nozzles. The purge tray may further have a bottom and one or more side walls. The bottom and one or more side walls together form a container for containing the purged fluid. Optionally, the purge tray may include a drain for removing the purged fluid from the purge tray. Optionally, or alternatively, the purge tray may be taken out by an operator to remove purged fluid, or the printer may be provided with a mechanism for pouring the purged liquid out of the purge tray. The purge tray may move underneath the at least one print unit in the printing range direction. The purge tray may move using suitable driving means.

In the method, in step of purging, at least part of the nozzles that are positioned above the purge tray are purged, while the nozzles that are not positioned above one of the purge tray or the wiping unit are not purged.

When purging at least part of the nozzles that are positioned above the purge tray, the fluid expelled from said nozzles is collected by the purge tray. In this way, the nozzles can be purged without polluting the printing device. At the same time, the nozzles that are not positioned above one of the purge tray or the wiping unit are not purged. If nozzles positioned above one of the purge tray or the wiping unit would be purged, then the purged fluid would not be collected by the purge tray, or absorbed by the wiping unit, and would hence pollute the printing device. By not purging the nozzles that are not positioned above one of the purge tray or the wiping unit, pollution of the printing device can be prevented.

In an embodiment, the print unit includes a number of nozzle groups, the plurality of nozzles extending in the printing range direction, wherein first a first group of nozzles is purged, while not purging the second group of nozzles and subsequently, the second group of nozzles is purged while not purging the first group of nozzles.

The purge tray may move underneath the at least one print unit in the printing range direction. By moving underneath the at least one print unit in the printing range direction, the purge tray may first be positioned underneath the first group of nozzles and at a later moment in time, the purge tray may be positioned underneath the second group of nozzles. The nozzles positioned above the purge tray may be purged. In case the purge tray moves from a first end of the at least one print unit in the printing range direction to a second end of the at least one print unit in the printing range direction, all nozzles may be purged, even though not all nozzles may be purged at the same time.

In an embodiment, the printing device further includes a wiping unit, wherein the method further comprises: Moving the wipe unit underneath the at least one print unit in the second direction.

Unwanted substances, including fluids and/or solid deposits may be present on the nozzle surface. The wiping unit may be configured to, in wiping operation, contact a surface of the print unit. The surface may be preferably the nozzle surface. By contacting a surface of the print unit, while moving underneath the print unit, the wiping unit may remove liquids or solids materials from the surface of the print unit, thereby cleaning the surface of the print unit. Examples of wiper units are wiper blades and tissue wipers.

Preferably, the wipe unit may move underneath the at least one print unit after the purge tray has moved underneath the at least one print unit. This allows the wipe unit to wipe away purged ink remaining on the surface of the at least one print unit, and any contamination still present on said surface after purging.

In a further embodiment, the printing device includes at least two wiping units, a first one of the at least two wiping units being configured to wipe a first print unit, a second one of the at least two wiping units being configured to wipe a second print unit, wherein the first and second wipe unit move synchronously.

By using at least two wiping units, wherein a first one of the at least two wiping units being configured to wipe a first print unit, and wherein a second one of the at least two wiping units being configured to wipe a second print unit, unwanted mixing of fluids on the surface of the print unit may be provided. Preferably, one wiping unit is provided per print unit in the printing system.

The first one and the second one of the at least two wiping units may move synchronously. When moving in the printing range direction, the position of the first one and the second one of the at least two wiping units in the first direction may be the same. This allows simultaneous wiping of print units.

In case the purge tray has a width in the first direction of at least the width of two print units, then a simultaneous movement of the first one and the second one of the at least two wiping units may allow the purge tray to collect fluids and other contaminants wiped away by the first one and the second one of the at least two wiping units, respectively.

In an embodiment, the wiping unit is positioned such that, in wiping operation, at least part of the wiping unit is positioned above the purge tray. In case the wiping unit is a tissue wiper including a pressing roller, at least part of the pressing roller may be positioned above the purge tray. In this way, the purge tray and the wiping unit are in close proximity of one another, which limits the amount of space needed. For example, the wiping unit may be positioned against the purge tray and the purge tray is in a position upstream in the printing range direction with respect to the position of the wiping unit.

### BRIEF DESCRIPTION OF THE DRAWINGS

The present disclosure will become more fully understood from the detailed description given herein below and accompanying schematical drawings which are given by way of illustration only and are not limitative of the disclosure.

FIG. 1 shows a schematic representation of an inkjet printing system.

FIGS. 2A-2B show a schematic representation of an inkjet marking device, particularly an assembly of inkjet heads; and FIG. 2C is a detailed view of a part of the assembly of inkjet heads.

FIGS. 3A-3D show a first example of a method for a printing device according to the present disclosure.

FIG. 4A-4B show a second example of a method for a printing device according to the present disclosure.

FIG. 5 shows a first example of a purge tray in accordance with the present disclosure.

### DESCRIPTION OF THE EMBODIMENTS

### Printing Process

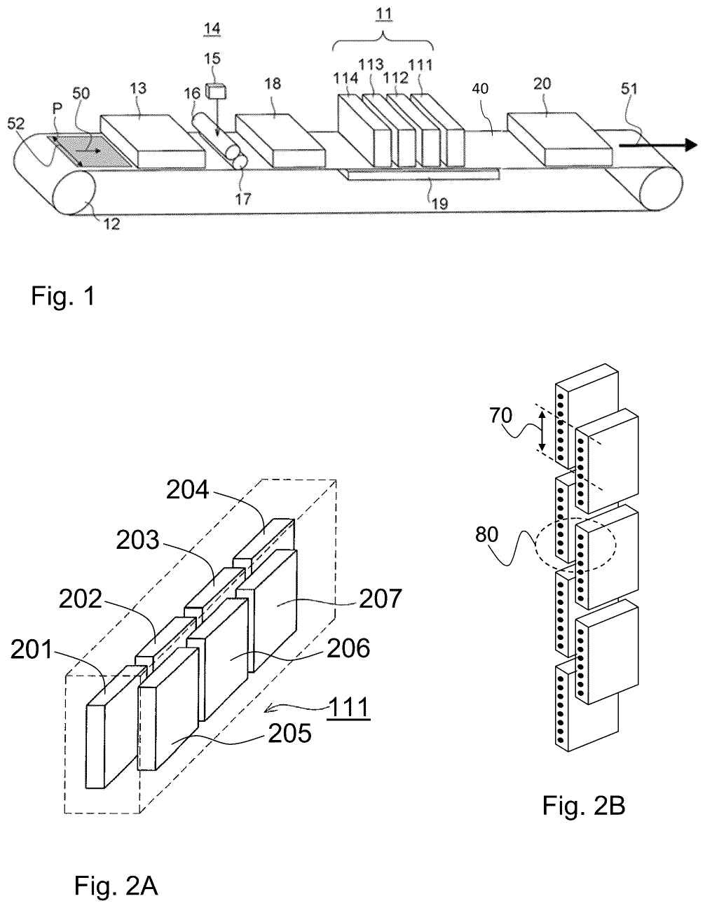

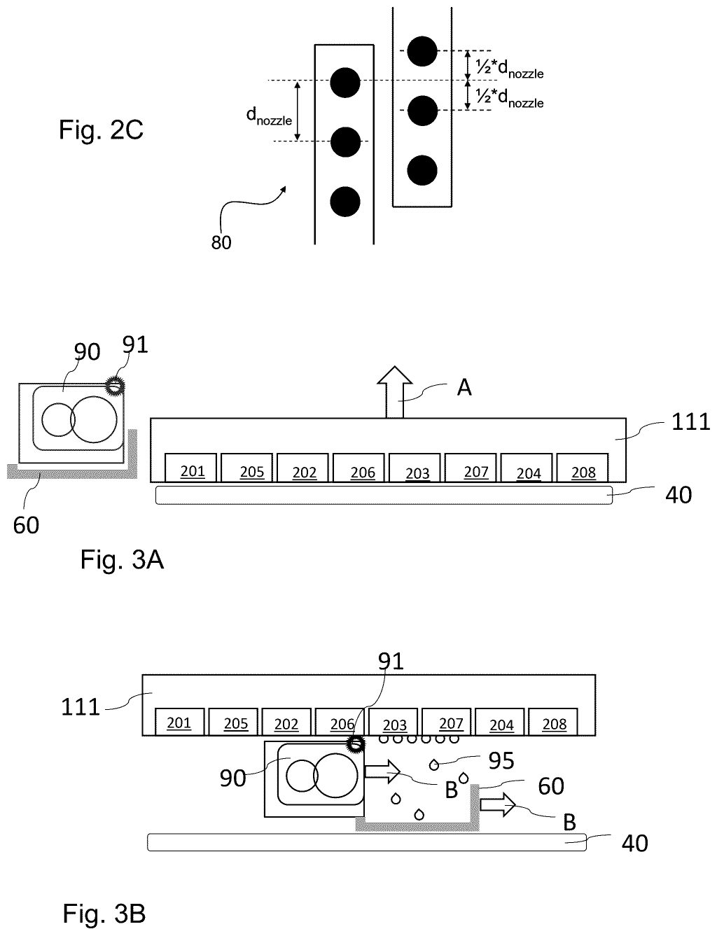

A printing process, in which the inks according to the present disclosure may be suitably used, is described with reference to the appended drawings shown in FIG. 1 and FIG. 2. FIGS. 1 and 2 show schematic representations of an inkjet printing system and inkjet marking device, respectively.

FIG. 1 shows a sheet of a receiving/recording medium, in particular a machine coated or offset coated medium, P, that is transported in a direction for conveyance as indicated by arrows 50 and 51 and with the aid of transportation mechanism/unit 12. Transportation mechanism 12 may be a driven belt system having one (as shown in FIG. 1) or more belts 40. Alternatively, one or more of these belts may be exchanged for one or more drums. A transportation mechanism may be suitably configured depending on the requirements (e.g. sheet registration accuracy) of the sheet transportation in each step of the printing process and may hence have one or more driven belts and/or one or more drums. For a proper conveyance of the sheets of receiving medium, the sheets need to be fixed to the transportation mechanism. The way of fixation is not particularly limited and may be selected from electrostatic fixation, mechanical fixation (e.g. clamping) and vacuum fixation. Of these, vacuum fixation is preferred.

The printing process as described below includes of the following steps: media pre-treatment, image formation, drying and fixing, and optionally post treatment.

### Media Pre-Treatment

To improve the spreading and pinning (i.e. fixation of pigments and water-dispersed polymer particles) of the ink on the receiving medium, in particular on slow absorbing media, such as machine coated or offset coated media, the receiving medium may be pretreated, i.e. treated prior to printing an image on the medium. The pre-treatment step may include one or more of the following:

Preheating of the receiving medium to enhance spreading of the used ink on the receiving medium and/or to enhance absorption of the used ink into the receiving medium.

Primer pre-treatment for increasing the surface tension of receiving medium in order to improve the wettability of the receiving medium by the used ink and to control the stability of the dispersed solid fraction of the ink composition (i.e. pigments and dispersed polymer particles). Primer pre-treatment may be performed in the gas phase, e.g. with gaseous acids such as hydrochloric acid, sulfuric acid, acetic acid, phosphoric acid and lactic acid, or in the liquid phase by coating the receiving medium with a pre-treatment liquid. The pre-treatment liquid may include water as a solvent, one or more cosolvents, additives such as surfactants and at least one compound selected from a polyvalent metal salt, an acid and a cationic resin (discussed in detail above).

### Primer Pre-Treatment

As an application method of the pre-treatment liquid, any conventionally known methods can be used. Specific examples of an application method include: a roller coating, an ink-jet application, a curtain coating and a spray coating. There is no specific restriction in the number of times with which the pre-treatment liquid is applied. It may be applied at one time, or it may be applied in two times or more. Application in two times or more may be preferable, since cockling of the coated printing paper can be prevented and the film formed by the surface pre-treatment liquid will produce a uniform dry surface having no wrinkle by applying in two (2) steps or more.

Especially, a roller coating (see 14 in FIG. 1) method is preferable because this coating method does not need to take into consideration ejection properties and it can apply the aqueous pre-treatment liquid homogeneously to a recording medium. In addition, the amount of the applied pre-treatment liquid with a roller or with other means to a recording medium can be suitably adjusted by controlling: the physical properties of the pre-treatment liquid; and the contact pressure of a roller in a roller coater to the recording medium and the rotational speed of a roller in a roller coater that is used for a coater of the pre-treatment liquid. As an application area of the pre-treatment liquid, it may be possible to apply only to the printed portion, or to the entire surface of both the printed portion and the non-printed portion. However, when the pre-treatment liquid is applied only to the printed portion, unevenness may occur between the application area and a non-application area caused by swelling of cellulose contained in the coated printing paper with the water in the pre-treatment liquid followed by drying. Then, from the viewpoint of drying uniformly, it is preferable to apply a pre-treatment liquid to the entire surface of a coated printing paper, and roller coating can be preferably used as a coating method to the whole surface.

### Corona or Plasma Treatment

Corona or plasma treatment may be used as a pre-treatment step by exposing a sheet of a receiving medium to corona discharge or plasma treatment. In particular, when used on media like polyethylene (PE) films, polypropylene (PP) films, polyethyleneterephtalate (PET) films and machine coated or offset coated media, the adhesion and spreading of the ink can be improved by increasing the surface energy of the media. With machine coated or offset coated media, the absorption of water can be promoted, which may induce faster fixation of the image and less puddling on the receiving medium. Surface properties of the receiving medium may be tuned by using different gases or gas mixtures as medium in the corona or plasma treatment. Examples are air, oxygen, nitrogen, carbon dioxide, methane, fluorine gas, argon, neon and mixtures thereof. Corona treatment in air is most preferred.

FIG. 1 shows that the sheet of receiving medium P may be conveyed to and passed through a first pre-treatment module 13, which module may include a preheater, for example a radiation heater, a corona/plasma treatment unit, a gaseous acid treatment unit or a combination of any of the above. Optionally and subsequently, a predetermined quantity of the aqueous pre-treatment liquid is applied on the surface of the receiving medium P at an aqueous pre-treatment liquid applying member 14. Specifically, the aqueous pre-treatment liquid is provided from storage tank 15 of the aqueous pre-treatment liquid to the aqueous pre-treatment liquid applying member 14 composed of double rolls 16 and 17. Each surface of the double rolls may be covered with a porous resin material such as a sponge. After providing the aqueous pre-treatment liquid to the auxiliary roll 16 first, the aqueous pre-treatment liquid is transferred to the main roll 17, and a predetermined quantity is applied on the surface of the receiving medium P. Subsequently, the coated printing paper P on which the aqueous pre-treatment liquid was supplied may optionally be heated and dried by a drying member 18, which is composed of a drying heater installed at the downstream position of the aqueous pre-treatment liquid applying member 14, in order to decrease the quantity of the water content in the aqueous pre-treatment liquid to a predetermined range. It is preferable to decrease the water content in an amount of 1.0 weight % to 30 weight % based on the total water content in the provided pre-treatment liquid provided on the receiving medium P.

To prevent the transportation mechanism 12 from being contaminated with pre-treatment liquid, a cleaning unit (not shown) may be installed and/or the transportation mechanism may be include multiple belts or drums as described above. The latter measure prevents contamination of the upstream parts of the transportation mechanism, in particular of the transportation mechanism in the printing region.

### Image Formation

Image formation is performed in such a manner that, employing an inkjet printer loaded with inkjet inks, ink droplets are ejected from the inkjet heads based on the digital signals onto a print medium.

Although both single pass inkjet printing and multi pass (i.e. scanning) inkjet printing may be used for image formation, single pass inkjet printing is preferably used since it is effective to perform high-speed printing. Single pass inkjet printing is an inkjet recording method with which ink droplets are deposited onto the receiving medium to form all pixels of the image by a single passage of a receiving medium underneath an inkjet marking module.

In FIG. 1, 11 represents an inkjet marking module including four inkjet marking devices, indicated with 111, 112, 113 and 114, each arranged to eject an ink of a different color (e.g. Cyan, Magenta, Yellow and black). The nozzle pitch of each head is e.g. about 360 dpi. In the present disclosure, “dpi” indicates a dot number per 2.54 cm.

An inkjet marking device for use in single pass inkjet printing, 111, 112, 113, 114, has a length, L, of at least the width of the desired printing range, indicated with double arrow 52, the printing range being perpendicular to the media transport direction, indicated with arrows 50 and 51. The inkjet marking device may include a single printhead having a length of at least the width of said desired printing range. The inkjet marking device may also be constructed by combining two or more inkjet heads, such that the combined lengths of the individual inkjet heads cover the entire width of the printing range. Such a constructed inkjet marking device is also termed a page wide array (PWA) of printheads. FIG. 2A shows an inkjet marking device 111 (112, 113, 114 may be identical) including seven (7) individual inkjet heads (201, 202, 203, 204, 205, 206, 207) that are arranged in two parallel rows, a first row including four inkjet heads (201-204) and a second row including three inkjet heads (205-207) that are arranged in a staggered configuration with respect to the inkjet heads of the first row. The staggered arrangement provides a page wide array of nozzles that are substantially equidistant in the length direction of the inkjet marking device. The staggered configuration may also provide a redundancy of nozzles in the area where the inkjet heads of the first row and the second row overlap, see 70 in FIG. 2B. Staggering may further be used to decrease the nozzle pitch (hence increasing the print resolution) in the length direction of the inkjet marking device, e.g. by arranging the second row of inkjet heads such that the positions of the nozzles of the inkjet heads of the second row are shifted in the length direction of the inkjet marking device by half the nozzle pitch, the nozzle pitch being the distance between adjacent nozzles in an inkjet head, d_{nozzle} (see FIG. 2C, which represents a detailed view of 80 in FIG. 2B). The resolution may be further increased by using more rows of inkjet heads, each of which are arranged such that the positions of the nozzles of each row are shifted in the length direction with respect to the positions of the nozzles of all other rows.

In image formation by ejecting an ink, an inkjet head (i.e. printhead) employed may be either an on-demand type or a continuous type inkjet head. As an ink ejection system, there may be usable either the electric-mechanical conversion system (e.g., a single-cavity type, a double-cavity type, a bender type, a piston type, a shear mode type, or a shared wall type), or an electric-thermal conversion system (e.g., a thermal inkjet type, or a Bubble Jet type (registered trade name)). Among them, it is preferable to use a piezo type inkjet recording head that has nozzles of a diameter of 30 μm or less in the current image forming method.

FIG. 1 shows that after pre-treatment, the receiving medium P is conveyed to an upstream part of the inkjet marking module 11. Then, image formation is carried out by each color ink ejecting from each inkjet marking device 111, 112, 113 and 114 arranged so that the whole width of the receiving medium P is covered.

Optionally, the image formation may be carried out while the receiving medium is temperature controlled. For this purpose, a temperature control device 19 may be arranged to control the temperature of the surface of the transportation mechanism (e.g. belt or drum) underneath the inkjet marking module 11. The temperature control device 19 may be used to control the surface temperature of the receiving medium P, for example in the range of 30° C. to 60° C. The temperature control device 19 may include heaters, such as radiation heaters, and a cooling means, for example a cold blast, in order to control the surface temperature of the receiving medium within said range. Subsequently and while printing, the receiving medium P is conveyed to the downstream part of the inkjet marking module 11.

### Drying and Fixing

After an image has been formed on the receiving medium, the prints have to be dried and the image has to be fixed onto the receiving medium. Drying includes the evaporation of solvents, in particular those solvents that have poor absorption characteristics with respect to the selected receiving medium.

FIG. 1 schematically shows a drying and fixing unit 20, which may include a heater, for example a radiation heater. After an image has been formed, the print is conveyed to and passed through the drying and fixing unit 20. The print is heated such that solvents present in the printed image, to a large extent water, evaporate. The speed of evaporation and hence drying may be enhanced by increasing the air refresh rate in the drying and fixing unit 20. Simultaneously, film formation of the ink occurs, because the prints are heated to a temperature above the minimum film formation temperature (MFFT). The residence time of the print in the drying and fixing unit 20 and the temperature at which the drying and fixing unit 20 operates are optimized, such that when the print leaves the drying and fixing unit 20 a dry and robust print has been obtained. As described above, the transportation mechanism 12 in the fixing and drying unit 20 may be separated from the transportation mechanism of the pre-treatment and printing section of the printing apparatus and may include a belt or a drum.

### Post Treatment

To increase the print robustness or other properties of a print, such as gloss level, the print may be post treated, which is an optional step in the printing process.

In an embodiment, the prints may be post treated by laminating the prints.

In an embodiment, the post-treatment step includes a step of applying (e.g. by jetting) a post-treatment liquid onto the surface of the coating layer, onto which the inkjet ink has been applied, so as to form a transparent protective layer on the printed recording medium. In the post-treatment step, the post-treatment liquid may be applied over the entire surface of an image on the recording medium or may be applied only to specific portions of the surface of an image. The method of applying the post-treatment liquid is not particularly limited and is selected from various methods depending on the type of the post-treatment liquid. However, the same method as used in the coating method of the pre-treatment liquid or an inkjet printing method is preferably used. Of these methods, inkjet printing method is particularly preferable in view of: avoiding contact between the printed image and the used post-treatment liquid applicator; the construction of an inkjet recording apparatus used; and the storage stability of the post-treatment liquid. In the post-treatment step, a post-treatment liquid containing a transparent resin is applied on the surface of a formed image so that a dry adhesion amount of the post-treatment liquid is 0.5 g/m² to 10 g/m², preferably 2 g/m² to 8 g/m², thereby forming a protective layer on the recording medium. When the dry adhesion amount is less than 0.5 g/m², almost no improvement in image quality (image density, color saturation, glossiness and fixability) is obtained. When the dry adhesion amount is more than 10 g/m², it is disadvantageous in cost efficiency, because the dryness of the protective layer degrades and the effect of improving the image quality is saturated.

As a post-treatment liquid, an aqueous solution including components capable of forming a transparent protective layer over a recording medium (e.g. a water-dispersible resin, a surfactant, water, and additives as required) is preferably used. The water-dispersible resin included in the post-treatment liquid, preferably has a glass transition temperature (T_{g}) of −30° C. or higher, and more preferably in the range of −20° C. to 100° C. The minimum film forming temperature (MFFT) of the water-dispersible resin is preferably 50° C. or lower, and more preferably 35° C. or lower. The water-dispersible resin may be radiation curable to improve the glossiness and fixability of the image.

As the water-dispersible resin, for example, an acrylic resin, a styrene-acrylic resin, a urethane resin, an acryl-silicone resin, a fluorine resin and the like are preferably used. The water-dispersible resin can be suitably selected from the same materials as that used for the inkjet ink. The amount of the water-dispersible resin contained, as a solid content, in the protective layer is preferably 1% by mass to 50% by mass. The surfactant comprised in the post-treatment liquid is not particularly limited and may be suitably selected from those used in the inkjet ink. Examples of the other components of the post-treatment liquid include antifungal agents, antifoaming agents, and pH adjustors.

Hitherto, the printing process was described such that the image formation step was performed in-line with the pre-treatment step (e.g. application of an (aqueous) pre-treatment liquid) and a drying and fixing step, all performed by the same apparatus (see FIG. 1). However, the printing process is not restricted to the above-mentioned embodiment. A method in which two or more machines are connected through a belt conveyor, drum conveyor or a roller, and the step of applying an aqueous pre-treatment liquid, the (optional) step of drying a coating solution, the step of ejecting an inkjet ink to form an image and the step or drying and fixing the printed image are performed. It is, however, preferable to carry out image formation with the above defined in-line image forming method.

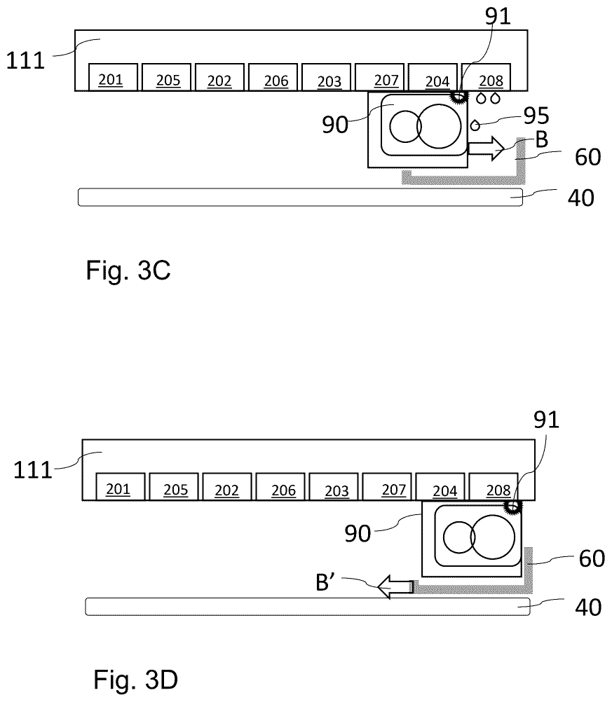

FIG. 3A-3D show a first example of a method for a printing device according to the present disclosure.

FIG. 3A shows an inkjet marking device 111, which is an example of a print unit. The print unit 111 includes eight individual inkjet heads 201-208. The print unit 111 is positioned above print belt 40.

FIG. 3A further shows a purge tray 60 and a wiping unit 90. The wiping unit 90 shown in FIG. 3A is a tissue wiper unit including a tissue (not shown) and a pressing roller 91 to guide the tissue and press it against a surface of the individual inkjet heads 201-208.

In printing operation, the position of the print unit 111 relative to the print belt 40 is as shown in FIG. 3A. However, the print unit can be moved in direction A to create more space between the print unit 111 and one or more maintenance units, such as the tissue wiper 90 and the purge tray 60.

In FIG. 3B, the print unit 111 has moved away from the print belt 40 in direction A with respect to the situation shown in FIG. 3A. Direction A, as shown in FIG. 3A, is a vertical direction. By moving away from the print belt 40, space is created between the print belt 40 and the print unit 111 to allow the purge tray 60 and the wiping unit 90 to move underneath the print unit 111.

As shown in FIG. 3B, the purge tray 60 and the wiping unit 90 move underneath the print unit 111 in direction B. Direction B, as shown in FIG. 3B, is a direction parallel to the surface of the print belt 40 and is essentially perpendicular to direction A.

Inkjet heads 203 and 207 are purging ink droplets 95. These ink droplets are collected by purge tray 60. After purging, some droplets may stay on the surface of the inkjet heads 203, 207. The wiping unit 90 moves in direction B, as does purge tray 60. The purge tray is more advanced in direction B than wiping unit 90. Hence, the wiping unit 90 can remove any remaining droplets 95 from the surface of the inkjet head 203, 207.

In FIG. 3C, the purge tray 60 has moved to the end of print unit 111. Inkjet head 208 purges ink, that is collected by the purge tray 60. The wiping unit 90 is still moving in direction B. While moving in direction B, the wiping unit 90 removes the remaining fluid form the surface of inkjet head 208. The wiping unit 90 slides into the purge tray 60. This is advantageous, since in this way only little space is needed for the purge tray 60 and the wiping unit 90.

In FIG. 3D, the wiping unit 90 has also moved to the end of print unit 111. The wiping unit is positioned above the purge tray 60. The purge tray 60 and the wiping unit 90 move in direction B′, which is opposite to direction B. By moving in direction B′, the purge tray and the wiping unit 90 may move back to a home position (not shown). Since the wiping unit 90 is placed above the purge tray 60, the wiping unit 90 and the purge tray 60 may be stored in the home position, needing relatively little space.

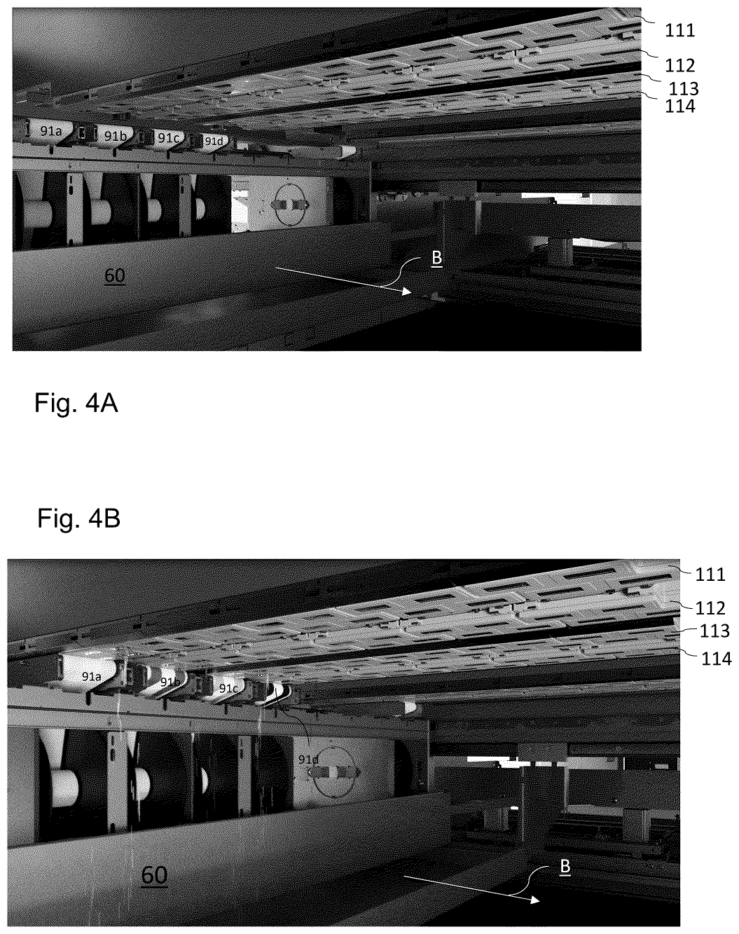

FIG. 4A-4B show a second example of a method for a printing device according to the present disclosure.

FIG. 4A shows a perspective view of a part of a printing device. The printing device includes a plurality of inkjet heads 111, 112, 113, 114, a purge tray 60, and a plurality of wiping units, each one of the wiping units including pressing rollers 91a, 91b, 91c, 91d. The purge tray as well as the wiping units including pressing rollers 91a, 91b, 91c, 91d move in direction B. The purge tray has a length extending in a direction parallel to direction B that is such, that the single purge tray 60 is capable of collecting droplets purged by all four inkjet heads 111, 112, 113, 114. The purge tray 60 is in a position more advanced in direction B than the wiping units including pressing rollers 91a, 91b, 91c, 91d. The purge tray 60 and the wiping units including pressing rollers 91a, 91b, 91c, 91d are positioned against one another.

In FIG. 4B, the purge tray 60 and the wiping units including pressing rollers 91a, 91b, 91c, 91d have advanced in direction B with regard to the situation shown in FIG. 4A. The tissue placed around pressing rollers 91b, 91c, 91d have taken up fluid from the surfaces of inkjet heads 112, 113, 114, respectively.

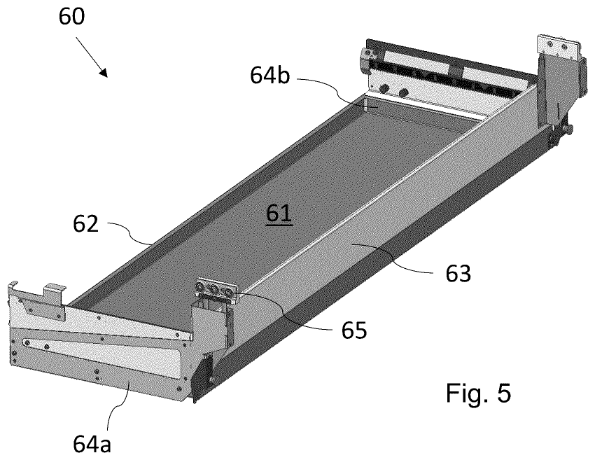

FIG. 5 shows a first example of a purge tray 60 in accordance with the present disclosure. The purge tray 60 includes a bottom wall 61. The purge tray further includes a rear wall 62, a front wall 63 and two side walls 64a, 64b. The bottom wall 61, the rear wall 62, the front wall 63 and two side walls 64a, 64b together form a container for collecting purged liquid. The front wall 63 is higher than the rear wall 62. The limited height of the rear wall 62 allows the purge tray to move at least partially under the wiping unit 90. The height of the front wall 63 allows to control the relative position of the wiping unit with regard to the purge tray.

The purge tray 60 is further provided with three wheels 65. The wheels 65 may guide the purge tray 60 along a guide rail. In an alternative embodiment, the purge tray 60 may be driven in an alternative way and/or the number of wheels provided on the purge tray 60 may be different from three (3).

Detailed embodiments of the present disclosure are disclosed herein; however, it is to be understood that the disclosed embodiments are merely exemplary of the disclosure, which can be embodied in various forms. Therefore, specific structural and functional details disclosed herein are not to be interpreted as limiting, but merely as a basis for the claims and as a representative basis for teaching one skilled in the art to variously employ the present disclosure in virtually and appropriately detailed structure. In particular, features presented and described in separate dependent claims may be applied in combination and any combination of such claims are herewith disclosed.

Further, the terms and phrases used herein are not intended to be limiting; but rather, to provide an understandable description of the disclosure. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

1. A printing device, comprising:
at least one print unit configured to, in a printing operation, apply a predetermined pattern of fluid onto a recording medium, the print unit comprising a plurality of nozzles;
a purge tray, the purge tray being configured to, in a purging operation, collect fluid purged from the at least one print unit; and
a recording medium transport unit configured to transport the recording medium in a transport direction,
wherein the at least one print unit has a length extending in a printing range direction, the printing range direction being perpendicular to the transport direction,
wherein the purge tray has a length extending in the printing range direction, the length of the purge tray being smaller than the length of the at least one print unit, and
wherein the purge tray is configured to, in the purging operation, move underneath the at least one print unit in the printing range direction.

2. The printing device according to claim 1, further comprising a wiping unit, the wiping unit being configured to, in a wiping operation, move underneath the at least one print unit in the printing range direction.

3. The printing device according to claim 2, wherein the wiping unit is a tissue wiper.

4. The printing device according to claim 2, wherein in the printing operation, the purge tray and the wiping unit are positioned in a home position, and wherein in the home position, one of the purge tray or the wiping unit is placed above the other one of the purge tray or the wiping unit.

5. The printing device according to claim 1, wherein the purge tray has a length in a first direction, the first direction being essentially parallel to the transport direction, the at least one print unit having a length in the first direction, wherein the length of the purge tray in the first direction is at least twice the length of the print unit in the first direction.

6. The printing device according to claim 5, further comprising at least two wiping units.

7. The printing device according to claim 1, further comprising a cleaning tray supporting the purge tray.

8. The printing device according to claim 7, further comprising:
a wiping unit, the wiping unit being configured to, in a wiping operation, move underneath the at least one print unit in the printing range direction; and
a cleaning tray supporting the wiping unit.

9. A method for maintaining the printing device according to claim 1, the method comprising:
moving the purge tray underneath the at least one print unit in the printing range direction; and
purging at least part of the nozzles that are positioned above the purge tray, while not purging the nozzles that are not positioned above the purge tray and the wiping unit.

10. The method according to claim 9, wherein the print unit comprises a number of nozzle groups, the plurality of nozzles being arranged in line in the printing range direction, the method further comprising firstly purging a first group of nozzles while not purging the second group of nozzles and subsequently purging the second group of nozzles while not purging the first group of nozzles.

11. The method according to claim 9, wherein the printing device further comprises a wiping unit, wherein the method further comprises:
moving the wipe unit underneath the at least one print unit in the printing range direction.

12. The method according to claim 9, wherein the printing device comprises at least two wiping units, a first one of the at least two wiping units being configured to wipe a first print unit, a second one of the at least two wiping units being configured to wipe a second print unit, wherein the method further comprising synchronously moving the first and second wiping units.
